(19) United States
(12) Patent Application Publication
(10) Pub. No.: US 2010/0148408 A1
(43) Pub. Date: Jun. 17, 2010

(54) Method of manufacturing a fiber reinforced plastic (FRP) lighting pole

(76) Inventor: Hai-Chou Yen, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/314,800

(22) Filed: Dec. 17, 2008

(51) Int. Cl. B29C 44/06

(52) U.S. Cl. 264/516

(57) ABSTRACT

A method for manufacturing a FRP lighting pole has a preparing step, a forming step and a departing step. The preparing step has acts of preparing a pre-impreganted sheet material (prepreg), an elastic internal mold and a rigidity external mold, wrapping the prepreg around the elastic internal mold. The forming step has acts of putting the prepreg into the rigidity external mold, pumping air into the elastic internal mold to make the prepreg being pressed between the molds and heating the rigidity external mold to make the prepreg curing. The departing step has acts of reducing the pressure of the elastic internal mold, lowering the temperature of the rigidity external mold and separating the cured prepreg (cured pole) both from the molds to form a finished FRP lighting pole.

### BACKGROUND OF THE INVENTION

1. Field of the Invention

The present invention relates to an entirely new method of manufacturing a fiber reinforced plastic (FRP) lighting pole, and more particularly to a method that can manufacture the FRP lighting pole conveniently, decrease the cost of manufacturing the FRP lighting pole and provide a uniform quality of the FRP lighting pole.

2. Description of the Prior Arts

Lighting poles are usually post supporting an outdoor lamp for illumination, are mounted on sides or a middle of a road to turn on and light at a certain time every night to provide an illuminant effect and are made of wood, steel, aluminum alloy and fiber reinforced plastic (FRP).

The discovery of materials with ever-improving physical properties has been an important contribution to the progress of humanity. In fact, one method of characterizing the various stages of mankind's progress has been to classify those stages according to the dominant material of the period: stone age, bronze age, iron age. Early in history, it was found that combinations of materials would produce properties in those materials that were superior to those of the separate components themselves for some uses. For instance: mud bricks reinforced with straw were used by ancient Israelites in Egypt.

While all of these combinations of materials could be called composites in the most general sense (because they consist of two or more identifiable constituents), so many natural and man-made materials would come under this definition that the category would be too broad for reasonable consideration. Therefore, a narrower and more useful definition of a composite would be: the combination of a reinforcement material (such as a particle or fiber) in a matrix or binder material. This definition implies that the materials act in concert—that is, one helping the other—hence the term reinforcement. In some cases, the matrix can be thought of as the glue type that binds the reinforcements together and protects the reinforcement from environmental effects. The term composite also implies that the materials are macroscopically identifiable, that is, the materials are not merely different at the molecular level but have distinctive component properties and they are generally mechanically separable. This definition excludes many materials that might have been included in the broader definition such as: metal alloys, solvent-swelled membranes, plastic copolymers, minerals, glasses and wood.

Fiberglass reinforced plastics (FRP) are a subdivision of the composites field in which matrix is a polymer (or plastic) and the reinforcement is always a fiber. This is the largest subdivision of composites. Common usage has now largely assigned the terms FRP or fiber reinforced plastics to the narrower field of fiberglass reinforcement of polyester resins.

The FRP lighting poles can be made by several conventional methods. These methods for manufacturing conventional FRP lighting poles include a centrifugal casting method, a filament winding method and a hand lay-up method.

In the centrifugal casting method, a fiber reinforcement is put in a high-speed centrifugal apparatus and infuses a resin into the centrifugal apparatus with a centrifugal force to wet and to mix with the fiber reinforcement, then cured to form the FRP lighting pole. Although, the centrifugal casting method can provide a uniform quality of the FRP lighting pole, but the centrifugal apparatus is expensive and is electricity consuming and this will increase the cost of manufacturing the conventional FRP lighting poles.

The filament winding method is soaking thoroughly a continuous filament in a resin tank and then winding around a rigidity mold by a winding machine, then cured to form the conventional FRP lighting pole, and a trimming process thru a lathe machine to trim the uneven or wave surface of the conventional FRP lighting pole after the winding process. However, the winding machine is expensive and needs a further trimming process, so this is time-consuming and will increase the cost of manufacturing the conventional FRP lighting poles.

The hand lay-up method needs to mix a fiber reinforcement and a resin into two FRP semi-cylinders by hand lay up and let cured, then combine the semi-cylinders with each other by a resin adhesive to form the conventional FRP lighting pole. Although, the hand lay-up method by using cheaper production machine can decrease the cost of manufacturing the conventional FRP lighting poles, but the structural strength of the conventional FRP lighting pole is not enough and may rend at the combining interface of the semi-cylinders.

In addition, the conventional FRP lighting pole usually has a shaft segment and an extended arm segment. The shaft segment of the conventional FRP lighting pole is used to mount on the ground. One end of the extended arm segment is connected to the shaft segment and the other end is used to connect a light or a lamp. However, the shaft segment and the extended arm segment of the conventional FRP lighting pole isn't formed by one-piece and this is time-consuming and will increase the cost of manufacturing the conventional FRP lighting poles.

To overcome the shortcomings, the present invention provides a method of manufacturing a FRP lighting pole to mitigate or obviate the aforementioned problems.

### SUMMARY OF THE INVENTION

The main objective of the present invention is to provide a method of manufacturing a FRP lighting pole that can manufacture the FRP lighting pole conveniently, decrease the cost for manufacturing the FRP lighting pole and provide a uniform quality of the FRP lighting pole.

The method of manufacturing a FRP lighting pole in accordance with the present invention has a preparing step, a forming step and a departing step. The preparing step comprises preparing a pre-impreganted sheet material (hereinafter called “prepreg”), an elastic internal mold and a rigidity external mold, cutting the prepreg into a specific length and shape and wrapping the prepreg around the elastic internal mold. The forming step comprises putting the prepreg and the elastic internal mold into the half-molds of the rigidity external mold, closing the rigidity external mold, pumping air into the elastic internal mold to make the prepreg being pressed between the rigidity external mold and the elastic internal mold and heating the rigidity external mold to make the prepreg curing. The departing step comprises reducing the pressure of the elastic internal mold, lowering the temperature of the rigidity external mold and separating the cured prepreg (cured pole) from both the elastic internal mold and the rigidity external mold to form a finished FRP lighting pole.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a method of manufacturing a FRP lighting pole in accordance with the present invention;

FIG. 2 is a perspective view of a prepreg placed between an elastic mold and two half molds of a rigidity external mold to form a FRP lighting pole by the method in FIG. 1;

FIG. 3 is an enlarged perspective view of the prepreg wrapped around an elastic internal mold in FIG. 2;

FIG. 4 is an operational perspective view of the molds used to process the method in FIG. 1;

FIG. 5 is a perspective view of another embodiment of a prepreg placed between an elastic mold and two half molds of a rigidity external mold to form a FRP lighting pole in one-piece by the method in FIG. 1;

FIG. 6 is an enlarged perspective view of another embodiment of two half molds of the rigidity external mold to form a FRP lighting pole by the method in FIG. 1;

FIG. 7 is an enlarged perspective view of another embodiment of two half molds of the rigidity external mold to form a FRP lighting pole by the method in FIG. 1;

FIG. 8 is an exploded perspective view of a further embodiment of a half-mold of the rigidity external mold in FIG. 2; and

FIG. 9 is a perspective view of another embodiment of a rigidity external mold in FIG. 2.

### DETAILED DESCRIPTION OF THE PREFERRED EMBODIMENTS

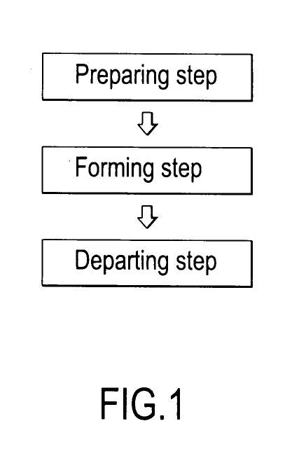

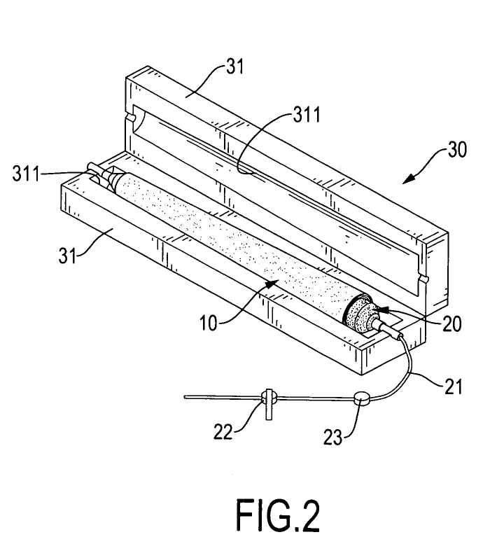

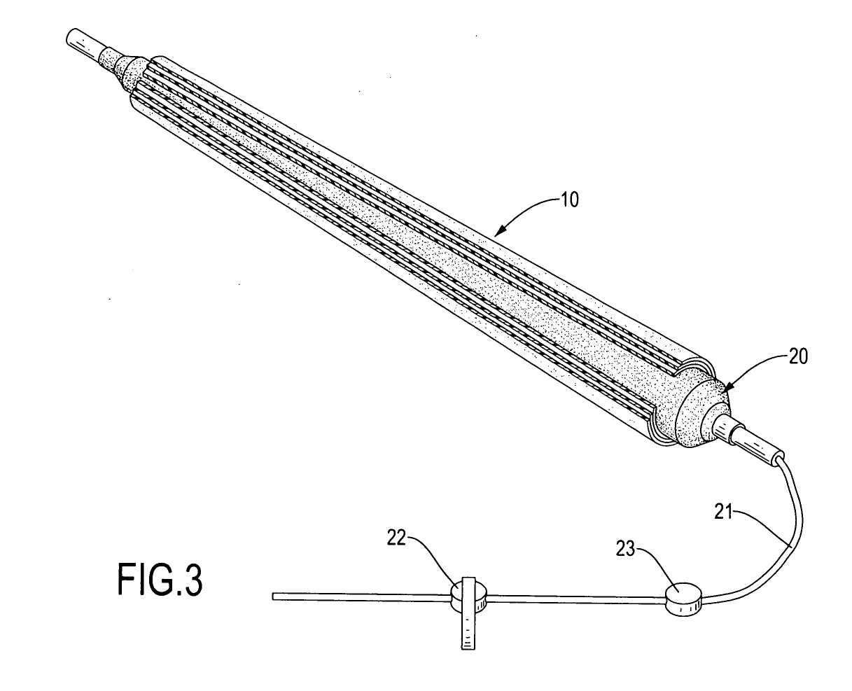

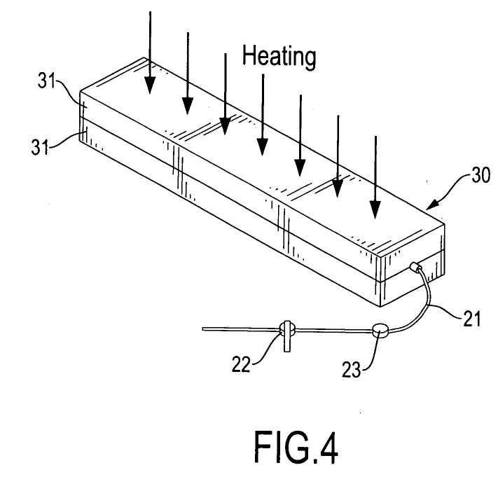

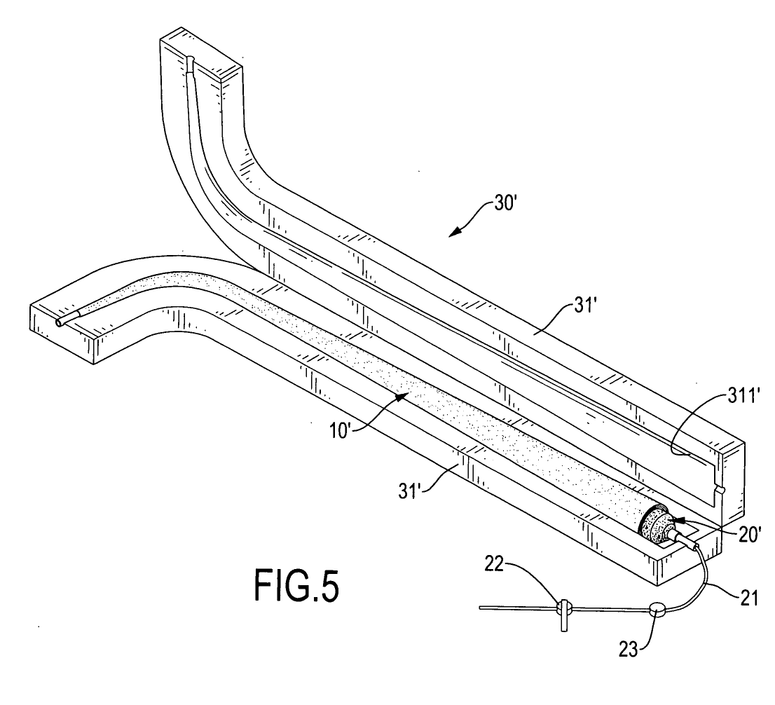

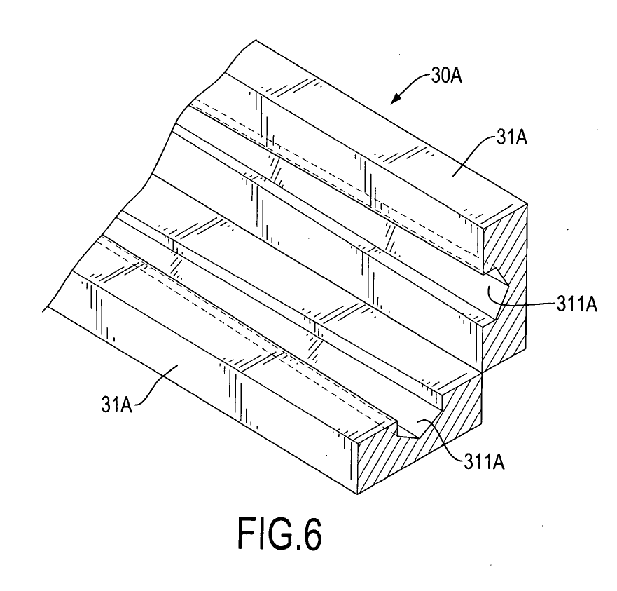

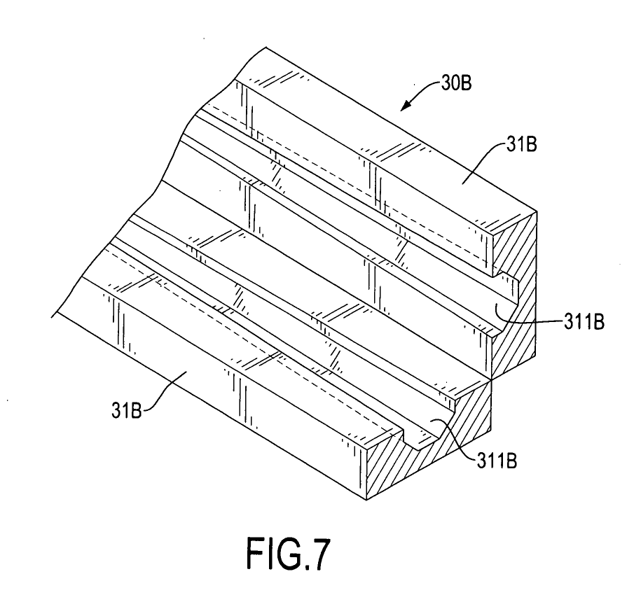

With reference to FIGS. 1 to 9, a method of making a fiber reinforced plastic (FRP) lighting pole in accordance with the present invention comprises a preparing step, a forming step and a departing step.

In the preparing step, preparing a pre-impreganted sheet material (10, 10′) (hereinafter called “prepreg”), an elastic internal mold (20, 20′) and a rigidity external mold (30, 30′, 30A, 30B, 30C). The prepreg (10, 10′) is made of a glass fiber as a fiber re-enforcement, an unsaturated polyester resin and a filler. The weight ratio of the fiber re-enforcement is 30˜65% and may be replaced by carbon fiber or natural fiber. The weight ratio of the unsaturated polyester resin is 50˜20% and may be replaced by epoxy resin or vinyl esters resin. The weight ratio of the filler is 0˜25% and may be calcium carbonate or aluminum hydroxide.

The elastic internal mold (20, 20′) may be a bag that is made of silicone rubber or rubber or synthetic rubber and can bear the air pressure about 3˜10 kg/cm² at the temperature of 140° C. and has a closed end, an opening end, an external surface, an optional reinforcing mandrel and an inlet tube (21). The reinforcing mandrel is formed axially inside of the elastic internal mold (20, 20′) to increase the rigidity strength of the elastic internal mold (20, 20′). The inlet tube (21) is connected to the elastic internal mold (20, 20′) and has a connecting end, an input end, a valve (22) and a pressure gauge (23). The connecting end of the inlet tube (21) is connected to the opening end of the elastic internal mold (20, 20′). The input end of the inlet tube (21) is connected to an air pump to pump air into the elastic internal mold (20). The valve (22) is mounted on the inlet tube (21) to control air flowing in the elastic internal mold (20, 20′). The pressure gauge (23) is mounted on the inlet tube (21) between the connecting end and the valve (22) to show the inner pressure of the elastic internal mold (20, 20′).

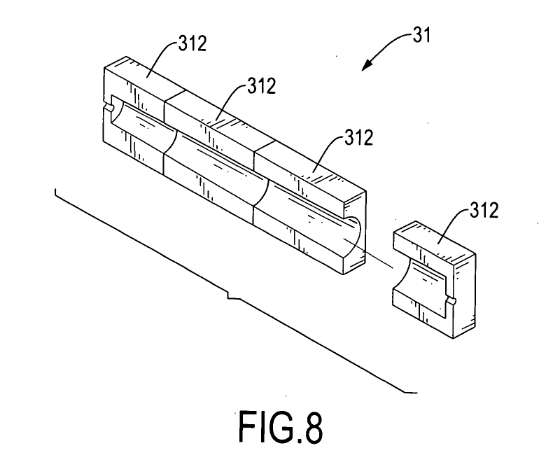

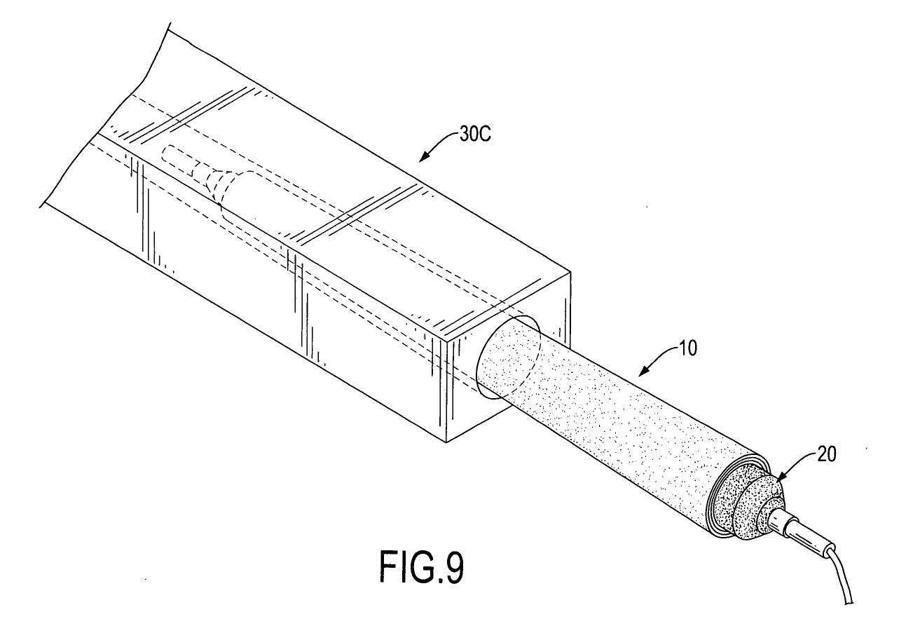

The rigidity external mold (30, 30′, 30A, 30B, 30C) may be made of steel, aluminum alloy or stainless steel, may be made by one-piece as shown in FIG. 9 and has two half-molds (31, 31′, 31A, 31B). The half-molds (31, 31′, 31A, 31B) are pivotally connected to each other and each half-mold (31, 31′, 31A, 31B) has an inner face and a cavity (311, 311′, 311A, 311B). The inner faces of the half-molds (31, 31′, 31A, 31B) are faced each other. The cavities (311, 311′, 311A, 311B) may be semi-cylinder shaped, semi-hexagonal shaped, semi-octagonal shaped, semi-polygonal cone or L-shaped that can make the shaft segment and the extended arm segment of the FRP lighting pole in one-piece, may be formed with a slope about 0˜1.8% and are respectively formed on the inner faces of the half-molds (31, 31′, 31A, 31B) and communicate with each other. Furthermore, with reference to FIG. 8, each half-mold (31) can be formed by multiple segmenting units (312). After preparing the prepreg (10, 10′) and the molds (20, 20′, 30, 30′, 30A, 30B, 30C), the prepreg (10, 10′) is cut into a specific length and shape, such as rectangular or a trapezoidal, painting or spraying a release agent on the external surface of the elastic internal mold (20, 20′) and wrapping the prepreg (10, 10′) around the external surface of the elastic internal mold (20, 20′). The release agent may be a wax or silicone type. In addition, the reinforcing mandrel that formed axially inside of the elastic internal mold (20, 20′) can let the prepreg (10, 10′) wrapping around the external surface of the elastic internal mold (20, 20′) easily.

In the forming step, the step comprises acts of coating the release agent on the cavities (311, 311′ , 311A, 311B) of the half-molds (31, 31′, 31A, 31B), putting the wrapped prepreg (10, 10′) and the elastic internal mold (20, 20′) into the cavities (311, 311′, 311A, 311B) of the half-molds (31, 31′, 31A, 31B) of the rigidity external mold (30, 30′, 30A, 30B) and closing the half-molds (31, 31′, 31A, 31B) of the rigidity external mold (30, 30′, 30A, 30B). Furthermore, when the rigidity external mold (30C) that made by one-piece, a user can close two opening ends of the rigidity external mold (30C). When the wrapped prepreg (10, 10′) and the elastic internal mold (20, 20′) are placed in the rigidity external mold (30, 30′, 30A, 30B, 30C), and air is pumped into the elastic internal mold (20, 20′) at 3˜10 kg/cm² to make the prepreg (10, 10′) being pressed between the cavities (311, 311′ , 311A, 311B) of the half-molds (31, 31′, 31A, 31B) and the external surface of the elastic internal mold (20, 20′). Then, the rigidity external mold (30, 30′, 30A, 30B, 30C) is heated to 60˜140° C. for 5˜15 minutes to make the prepreg (10, 10′) curing.

In the departing step, the step includes acts of reducing the pressure of the elastic internal mold (20, 20′) to zero by releasing air from the elastic internal mold (20, 20′) and lowering the temperature of the rigidity external mold (30, 30′, 30A, 30B, 30C). Then, the cured prepreg (cured pole) (10, 10′) is separated from the elastic internal mold (20, 20′) and the rigidity external mold (30, 30′, 30A, 30B, 30C) to form a FRP lighting pole.

The method of manufacturing a FRP lighting pole as described has the following advantages.

1. The method of the present invention only needs to put the prepreg (10, 10′) and the elastic internal mold (20, 20′) in the rigidity external mold (30, 30′, 30A, 30B, 30C), curing the prepreg (10, 10′) by heating the external molds (30, 30′, 30A, 30B, 30C) and separate the cured prepreg (10, 10′) from the molds (20, 20′, 30, 30′, 30A, 30B, 30C ). Consequently, a shaft segment and an extended arm segment of a FRP lighting pole can be manufactured in one-piece by the method of the present invention conveniently, and this is time-saving and will decrease the cost of manufacturing the FRP lighting poles.

2. The method of the present invention can manufacture a FRP lighting pole by the structure-simplified molds (20, 20′, 30, 30′, 30A, 30B, 30C ) and without using any expensive machines and the production facility investment is comparatively much lower.

3. The FRP lighting pole that manufactured by the method of the present invention is using the prepreg as raw material. Since the material we use is of sheet type, it is easy to wrap on the internal mold (20, 20′) and to obtain even thickness and uniform quality for the FRP lighting pole.

4. The method of the present invention that using the prepreg as raw material can get better control on the Volatile Organic Compounds (VOCs) with less air pollution to the environment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of manufacturing a fiber reinforced plastic (FRP) lighting pole comprising steps of:
a preparing step comprising:
preparing a pre-impreganted sheet material (hereinafter called “prepreg”), an elastic internal mold with an external surface and a rigidity external mold;
cutting the prepreg;
wrapping the prepreg around the external surface of the elastic internal mold;
a forming step comprising:
putting the prepreg and the elastic internal mold into the rigidity external mold and closing the rigidity external mold;
pumping air into the elastic internal mold to make the prepreg being pressed between the rigidity external mold and the elastic internal mold; and
heating the rigidity external mold to make the prepreg curing; and
a departing step comprising:
reducing the pressure of the elastic internal mold and lowering the temperature of the rigidity external mold; and
separating the cured prepreg from the elastic internal mold and the rigidity external mold to form a FRP lighting pole.

2. The method as claimed in claim 1, wherein the preparing step further comprises painting or spraying a release agent on the external surface of the elastic internal mold before wrapping the prepreg around the elastic internal mold.

3. The method as claimed in claim 2, wherein the preparing step further comprises preparing the elastic internal mold with an inlet tube to fill air in the elastic internal mold, a valve to control air flowing in the elastic internal mold and a pressure gauge to show the inner pressure of the elastic internal mold.

4. The method as claimed in claim 3, wherein the rigidity external mold further has two half-molds and the preparing step further comprises forming cavities respectively in the half-molds of the rigidity external mold, and the prepreg and the elastic internal mold are placed in the cavities of the half-molds.

5. The method as claimed in claim 4, wherein the forming step further comprises painting or spraying a release agent on the cavities of the half-molds before putting the prepreg and the elastic internal mold in the rigidity external mold.

6. The method as claimed in claim 5, wherein the prepreg is composed of a glass fiber as a fiber re-enforcement, an unsaturated polyester resin and a filler, and the weight ratio of the fiber re-enforcement is 30˜65%, the weight ratio of the unsaturated polyester resin is 50˜20% and the weight ratio of the filler is 0˜25%.

7. The method as claimed in claim 5, wherein the prepreg is composed of a glass fiber as a fiber re-enforcement, an epoxy resin and a filler, and the weight ratio of the fiber re-enforcement is 30˜65%, the weight ratio of the epoxy resin is 50˜20% and the weight ratio of the filler is 0˜25%.

8. The method as claimed in claim 5, wherein the prepreg is composed of a glass fiber as a fiber re-enforcement, an vinyl esters resin and a filler, and the weight ratio of the fiber re-enforcement is 30˜65%, the weight ratio of the vinyl esters resin is 50˜20% and the weight ratio of the filler is 0˜25%.

9. The method as claimed in claim 5, wherein the prepreg is composed of a carbon fiber as a fiber re-enforcement, an unsaturated polyester resin and a filler, and the weight ratio of the fiber re-enforcement is 30˜65%, the weight ratio of the unsaturated polyester resin is 50˜20% and the weight ratio of the filler is 0˜25%.

10. The method as claimed in claim 5, wherein the prepreg is composed of a carbon fiber as a fiber re-enforcement, an epoxy resin and a filler, and the weight ratio of the fiber re-enforcement is 30˜65%, the weight ratio of the epoxy resin is 50˜20% and the weight ratio of the filler is 0˜25%.

11. The method as claimed in claim 5, wherein the prepreg is composed of a carbon fiber as a fiber re-enforcement, an vinyl esters resin and a filler, and the weight ratio of the fiber re-enforcement is 30˜65%, the weight ratio of the vinyl esters resin is 50˜20% and the weight ratio of the filler is 0˜25%.

12. The method as claimed in claim 5, wherein the preparing step further comprises forming two semi-cylinder shaped cavities respectively in the half-molds, and the prepreg and the elastic internal mold are placed in the cavities of the half-molds.

13. The method as claimed in claim 5, wherein the preparing step further comprises forming two semi-polygonal cone shaped cavities respectively in the half-molds, and the prepreg and the elastic internal mold are placed in the cavities of the half-molds.

14. The method as claimed in claim 5, wherein the preparing step further comprises forming two semi-hexagonal cone shaped cavities respectively in the half-molds, and the prepreg and the elastic internal mold are placed in the cavities of the half-molds.

15. The method as claimed in claim 5, wherein the preparing step further comprises forming two semi-octagonal cone shaped cavities respectively in the half-molds, and the prepreg and the elastic internal mold are placed in the cavities of the half-molds.

16. The method as claimed in claim 5, wherein the preparing step further comprises forming two L-shaped cavities respectively in the half-molds, and the prepreg and the elastic internal mold are placed in the cavities of the half-molds to form a shaft segment and an extended arm segment of the FRP lighting pole in one-piece.

17. The method as claimed in claim 5, wherein the preparing step further comprises forming the cavities of the half-molds with a slope about 0˜1.8% respectively in the half-molds, and the prepreg and the elastic internal mold are placed in the cavities of the half-molds.

18. The method as claimed in claim 5, wherein the preparing step further comprises preparing a bag that made of silicone rubber and has a capability of bearing the air pressure about 3˜10 kg/cm² at the temperature of 140° C. to form the elastic internal mold.

19. The method as claimed in claim 5, wherein the preparing step further comprises preparing a bag that made of rubber and has a capability of bearing the air pressure about 3˜10 kg/cm²and the temperature at 140° C. to form the elastic internal mold.

20. The method as claimed in claim 5, wherein in the preparing step, the rigidity external mold is made by one-piece.

21. The method as claimed in claim 5, wherein in the preparing step, forming a reinforcing mandrel axially inside of the elastic internal mold to increase the rigidity strength of the elastic internal mold.

22. The method as claimed in claim 5, wherein in the preparing step, pumping air into the elastic internal mold at 3˜10 kg/cm² and heating the rigidity external mold to 60˜140° C.

23. The method as claimed in claim 5, wherein in the preparing step, each half-mold of the rigidity external mold is made by multiple segmenting units.
